(19) United States
(12) Patent Application Publication
(10) Pub. No.: US 2025/0378574 A1
(43) Pub. Date: Dec. 11, 2025

(54) EGO-BODY POSE ESTIMATION

(71) Applicant: Honda Motor Co., Ltd., Tokyo (JP)

(72) Inventors: Seunggeun CHI, West Lafayette, IN (US); Pin-Hao HUANG, San Jose, CA (US); Enna SACHDEVA, Santa Clara, CA (US); Hengbo MA, Mountain View, CA (US); Kwonjoon LEE, Sunnyvale, CA (US)

(21) Appl. No.: 19/096,200

(22) Filed: Mar. 31, 2025

Related U.S. Application Data
(60) Provisional application No. 63/656,884, filed on Jun. 6, 2024.

(51) Int. Cl. G06T 7/73; G06F 3/01; G06T 5/70; G06T 7/20

(52) U.S. Cl. CPC G06T 7/73; G06F 3/012; G06T 5/70; G06T 7/20; G06T 2207/30241

(57) ABSTRACT

According to one aspect, ego-body pose estimation may include imputing a trajectory and a pose for a hand of a human based on an ego-centric input video and an input head tracking signal, generating a whole-body pose for the human based on the trajectory and the pose for the hand and by denoising the trajectory and the pose of the hand, and implementing an action based on the whole-body pose determined for the human via an actuator.

### CROSS-REFERENCE TO RELATED APPLICATIONS

This application claims the benefit of U.S. Provisional Patent Application, Ser. No. 63/656,884 (Attorney Docket No. HRA-56141) entitled “EGO-BODY POSE ESTIMATION”, filed on Jun. 6, 2024; the entirety of the above-noted application(s) is incorporated by reference herein.

### BACKGROUND

Pose estimation is a computer vision task where the goal is to detect the position and orientation of a person or an object. Usually, this is done by predicting the location of specific key points like hands, head, elbows, etc. in the case of human pose estimation. Pose estimation is a fundamental task in computer vision and artificial intelligence (AI) that involves detecting and tracking the position and orientation of human body parts in images or videos.

### BRIEF DESCRIPTION

According to one aspect, a system for ego-body pose estimation may include a processor and a memory. The memory may store one or more instructions. The processor may execute one or more of the instructions stored on the memory to perform one or more acts, actions, and/or steps. For example, the processor may impute a trajectory and a pose for a hand of a human based on an ego-centric input video and an input head tracking signal. The processor may generate a whole-body pose for the human based on the trajectory and the pose for the hand and by denoising the trajectory and the pose of the hand.

The system for ego-body pose estimation may include an actuator implementing an action based on the whole-body pose determined for the human. The processor may impute the trajectory and the pose for the hand of the human by passing input data including the input video and the input head tracking signal through a mask auto encoder (MAE). The MAE may not require the same number of frames between the input video and a number of unknown frames. The input data may be temporally sparse and spatially sparse. The input data may include joint information from only the hand of the human and a head of the human. The input video may include one or more frames where the hand of the human may be visible and one or more frames where the hand of the human may be not visible.

The whole-body pose for the human may be generated by passing the imputed trajectory and pose for the hand of the human through a denoising transformer. The denoising transformer may include a diffusion model. The generating the whole-body pose for the human may be based on a Vector Quantized-Variational Auto-Encoder (VQ-VAE).

According to one aspect, a computer-implemented method for ego-body pose estimation may include imputing a trajectory and a pose for a hand of a human based on an ego-centric input video and an input head tracking signal and generating a whole-body pose for the human based on the trajectory and the pose for the hand and by denoising the trajectory and the pose of the hand.

The computer-implemented method for ego-body pose estimation may include implementing an action based on the whole-body pose determined for the human via an actuator. The imputing of the trajectory and the pose for the hand of the human may be based on passing input data including the input video and the input head tracking signal through a mask auto encoder (MAE). The input data may be temporally sparse and spatially sparse. The input data may include joint information from only the hand of the human and a head of the human.

According to one aspect, a system for ego-body pose estimation may include a sensor, a memory, and a processor. The sensor may receive an ego-centric input video and an input head tracking signal. The memory may store one or more instructions. The processor may execute one or more of the instructions stored on the memory to perform one or more acts, actions, and/or steps. The processor may impute a trajectory and a pose for a hand of a human based on the ego-centric input video and the input head tracking signal. The processor may generate a whole-body pose for the human based on the trajectory and the pose for the hand and by denoising the trajectory and the pose of the hand.

The system for ego-body pose estimation may include an actuator implementing an action based on the whole-body pose determined for the human. The processor may impute the trajectory and the pose for the hand of the human by passing input data including the input video and the input head tracking signal through a mask auto encoder (MAE). The input data may be temporally sparse and spatially sparse. The input data may include joint information from only the hand of the human and a head of the human.

### BRIEF DESCRIPTION OF THE DRAWINGS

FIG. 1 is an exemplary component diagram of a system for ego-body pose estimation, according to one aspect.

FIG. 2 is an exemplary architecture associated with the system for ego-body pose estimation of FIG. 1, according to one aspect.

FIGS. 3A-3C are exemplary aspects related to ego-body pose estimation, according to one aspect.

FIG. 4 is an exemplary flow diagram of a computer-implemented method for ego-body pose estimation, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device, or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual system that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

Ego-body pose estimation ma include estimating the body movements of a camera wearer from ego-centric input videos. Even temporally sparse observations, such as hand poses captured intermittently from ego-centric videos during natural or periodic hand movements, may effectively constrain overall body motion. Naively applying diffusion models to generate full-body pose from head pose and sparse hand pose may lead to suboptimal results. To overcome this, ego-body pose estimation including a two-stage approach that decomposes the ego-body pose estimation problem into a temporal completion stage and a spatial completion stage is provided herein. According to one aspect, ego-body pose estimation may employ one or more masked autoencoders to impute hand trajectories by leveraging the spatiotemporal correlations between the head pose sequence and intermittent hand poses, providing uncertainty estimates. Additionally, conditional diffusion models may be employed to generate plausible full-body motions based on these temporally dense trajectories of the head and hands, guided by the uncertainty estimates from the imputation.

As discussed, even temporally sparse observations, such as hand poses captured intermittently from ego-centric videos during natural or periodic hand movements, may effectively constrain overall body motion. While it may be possible to utilize other visible body parts, such as feet or elbows, merely hand poses are discussed. In this regard, ego-body pose estimation may incorporate temporal completion by leveraging the intermittent appearance of hands in ego-centric input videos. This dual completion approach not only enhances the robustness of body pose estimation under varying conditions but also reduces reliance on specific sensor hardware, making it more adaptable to various augmented reality (AR) environments.

According to one aspect, a system for ego-body pose estimation may use temporally sparse 3D hand poses from detections in ego-centric input videos combined with dense head tracking signals (e.g., an input head tracking signal) to reconstruct the full body ego-body pose estimation. Initially, the system for ego-body pose estimation may temporally complete sparse hand information using a mask auto encoder (MAE), which may estimate hand pose trajectories by capturing the spatiotemporal correlations between intermittent hand poses and head tracking signals. The system for ego-body pose estimation may develop a probabilistic extension of the MAE to provide uncertainty estimates of the predicted hand pose sequence. According to one aspect, the system for ego-body pose estimation may utilize a conditional diffusion model to spatially reconstruct the full body ego-body pose estimation based on the head tracking signal data and imputed hand trajectories along with their predictive uncertainties. The system for ego-body pose estimation may effectively utilize data that is doubly sparse (e.g., sparse both temporally and spatially).

This flexible framework may be designed to seamlessly adapt to diverse AR and/or VR setups and devices, ranging from spatially sparse scenarios (e.g., using only head tracking signal or combining it with hand controllers) to doubly sparse scenarios (e.g., utilizing head signal data alongside hand detection from ego-centric video). One advantage provided by the framework may be based on an assumption that a head mounted display (HMD) tracking signal is available, enabling the approach to function across a wide range of environments and hardware configurations. By addressing both temporal completion and spatial completion through the double completion approach, a robust and adaptable solution that reduces dependency on specific sensor hardware may be provided, making it well-suited for immersive AR experiences in diverse scenarios, such as sports training, outdoor environments, etc.

In this way, a robust and versatile framework for ego-centric body poses estimation tailored for HMDs is provided. The framework for the system for ego-body pose estimation provided the advantage of adapting to various AR/VR settings and may leverage tracking signals available in most modern HMD devices without the requirement of any controllers. Further, because the problem of ego-body pose estimation is decomposed into a temporal completion stage and a spatial completion stage, computational complexity is reduced. This approach may capture the uncertainty from hand trajectory imputation to guide the diffusion model for accurate full-body motion generation.

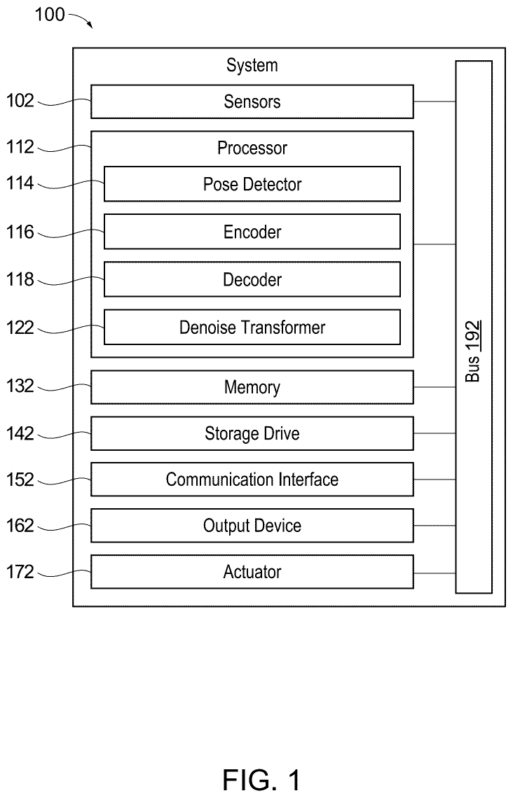

FIG. 1 is an exemplary component diagram of a system 100 for ego-body pose estimation, according to one aspect. The system 100 for ego-body pose estimation may include one or more sensors 102 and a processor 112. The processor 112 may include a pose detector 114, an encoder 116, a decoder 118, or a denoise transformer 122. The pose detector 114, the encoder 116, the decoder 118, and the denoise transformer 122 may be implemented via the processor 112, the memory 132, and/or the storage drive 142. The system 100 for ego-body pose estimation may include a memory 132, a storage drive 142, a communication interface 152, an output device 162, one or more actuators 172, and a bus 192. The bus 192 may form an operable connection between one or more components of the system 100 for ego-body pose estimation, such as the sensors 102, the processor 112, the memory 132, the storage drive 142, the communication interface 152, the output device 162, and the actuator. In this way, the computer communication may be achieved between respective components.

One or more of the sensors 102 may be an image capture device. For example, the image capture device may capture an egocentric input video of a human or an individual. According to one aspect, one or more of the sensors 102 may be mounted to a headset. In this regard, the ego-centric input video may be taken from the perspective of the human or from a perspective near a head of the human. One or more of the sensors 102 may be a tracking device. The tracking device may track the movement of the human's head and output or generate an input head tracking signal accordingly.

The memory 132 may store one or more instructions. The processor 112 may execute one or more of the instructions stored on the memory 132 to perform one or more acts, actions, and/or steps.

The processor 112 may impute a trajectory and a pose for a hand of a human based on an ego-centric input video and an input head tracking signal using the pose detector 114. Together, the ego-centric input video and the input head tracking signal may be considered to be input data. The input data may be temporally sparse and spatially sparse. According to one aspect, the input data may include joint information from only the hand of the human and a head of the human and may be considered to be spatially sparse or positionally sparse in this regard. Additionally, the input video may include one or more frames where the hand of the human may be visible and one or more frames where the hand of the human may be not visible, and may thus be considered to be temporally sparse in this regard.

The processor 112 may impute the trajectory and the pose for the hand of the human by passing input data including the input video and the input head tracking signal through a mask auto encoder (MAE), which may include the encoder 116. The MAE may not require the same number of frames between the input video and a number of unknown frames.

The processor 112 may generate a whole-body pose for the human based on the trajectory and the pose for the hand and by denoising the trajectory and the pose of the hand. For example, the whole-body pose for the human may be generated by passing the imputed trajectory and pose for the hand of the human through the denoising transformer 122. The denoising transformer 122 may include a diffusion model. The diffusion model may be received via the communication interface 152 and stored on the storage drive 142. The generating the whole-body pose for the human may be based on a Vector Quantized-Variational Auto-Encoder (VQ-VAE).

According to one aspect, the output device 162 may include a display to display or output the generated whole-body pose for the human. According to one aspect, the system 100 for ego-body pose estimation may include the actuators 172 implementing an action based on the whole-body pose determined for the human. For example, the actuator 172 may move a robotic arm or appendage from a first position to a second position based on the whole-body pose determined for the human.

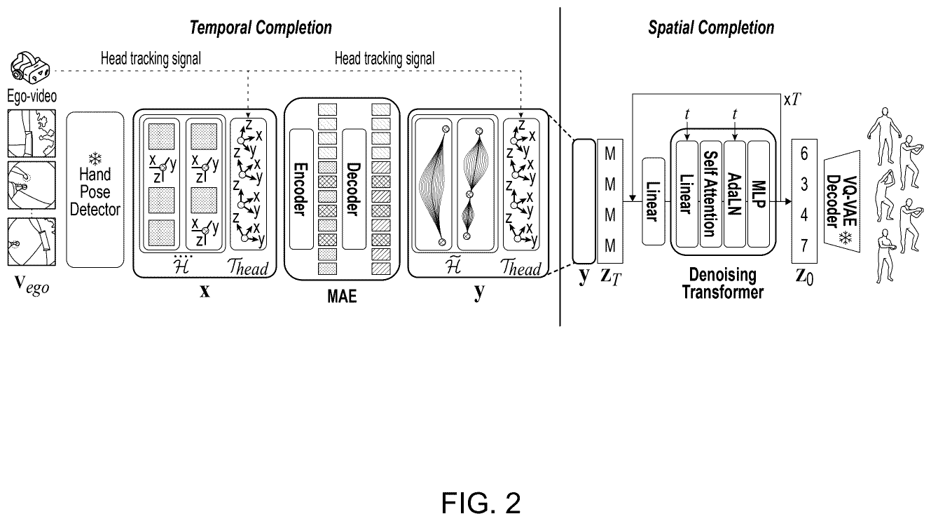

FIG. 2 is an exemplary architecture associated with the system 100 for ego-body pose estimation of FIG. 1, according to one aspect. FIG. 2 illustrates an overall pipeline for the system 100 for ego-body pose estimation, including a temporal completion stage and a spatial completion stage to address pose estimation from doubly sparse data. Ego-body pose estimation is now described with respect to both FIGS. 1-2.

### Problem Formulation

The processor 112 may estimate the 3D human pose of an HMD user from sequences of RGB video and a head tracking signal using the pose detector 114. The head tracking signal data may be received from an internal measurement unit (IMU) from most any HMD. The processor 112 may receive an ego-centric input video [symbol] _{ego}={ [symbol] ₁, . . . , [symbol] _{T}_{_{W}}}, where [symbol] _{τ} may be an RGB image and T_{w} denotes the sequence length, and a corresponding head tracking signal sequence [symbol] _{head}={ [symbol] ₁, . . . , [symbol] _{T}_{_{W}}}, where [symbol] _{τ}∈ [symbol] and [symbol] _{head} may be a dimension of the head tracking signal including 3D pose. The goal may be to estimate the full ego-body pose [symbol] ={ [symbol] ₁, . . . , [symbol] _{T}_{_{W}}}, where a pose state [symbol] _{τ}∈ [symbol] ^{J×D} at time τ, J may be a number of body joints and D may be the dimensionality of pose state. The processor 112 may solve the ego-body pose estimation problem of estimating p( [symbol] | [symbol] _{ego}, [symbol] _{head}) by decomposing the ego-body pose estimation problem into two stages, including imputation and generation, assuming that temporally sparse hand data [symbol] may be provided from one or more sensors 102, such as a hand detection sensor f(⋅): [symbol] =f( [symbol] _{ego}). According to one aspect, the processor 112 may temporally complete a hand trajectory [symbol] based on [symbol] and [symbol] _{head}, which may be written as p( [symbol] | [symbol] , [symbol] _{head}). Additionally, the processor 112 may spatially complete full body pose [symbol] from the imputed hands [symbol] and [symbol] _{head}, which may be written as p( [symbol] | [symbol] , [symbol] _{head}). Since [symbol] is a probabilistic variable, the processor 112 may marginalize over [symbol] as follows:

$$p ( 𝒫 \vert {𝒱}_{ego} , {𝒯}_{head} ) = {\int }_{\tilde{ℋ}} p ( 𝒫 \vert \tilde{ℋ} , {𝒯}_{head} ) p ( \tilde{ℋ} \vert f ( {𝒱}_{ego} ) , {𝒯}_{head} ) \qquad ( 1 )$$

Hand Pose Estimation from Ego-Centric Video

The processor 112 may estimate the 3D position of the hand from an ego-centric camera using a two-step process. According to one aspect, the processor 112 may predict hand poses as SMPL-X parameters, from which extract local 3D hand joint positions relative to the root of the hand model's kinematic tree, denoted as

$${ℋ}_{h}^{3 D} ∈ {ℝ}^{21 \times 3} .$$

According to one aspect, the processor 112 may use RTM-Pose to estimate 2D hand joint positions within an image,

$${ℋ}_{I}^{2 D} ∈ {ℝ}^{21 \times 2} .$$

Further, the processor 112 may determine the 3D hand joint positions in the camera coordinate system,

$${ℋ}_{I}^{3 D} = {ℋ}_{h}^{3 D} + d$$

by solving for d∈ [symbol] ³ that minimizes the reprojection error

$${‖ {ℋ}_{I}^{2 D} - K ( {ℋ}_{h}^{3 D} + d ) ‖}_{2} .$$

Here, K may be the intrinsic matrix, obtained by the processor 112 by transforming the original camera parameters into a pinhole model through undistortion. The pinhole model may be received via the communication interface 152 and stored on the storage drive 142.

### Temporal Completion

Temporal Completion-Hand Trajectory Imputation from Sparse Hand Pose

The processor 112 may employ an MAE to impute missing hand trajectories using the head tracking signal [symbol] _{head} and a detected hand pose [symbol] . The processor 112 may treat each [symbol] _{τ} and [symbol] at time τ as a token similar to an image patch in a vision transformer. To accommodate this, the processor 112 may implement two embedding layers, one for the head tracking signal [symbol] _{τ}∈ [symbol] ^{D}^{_{head}} and the other for the hand [symbol] ∈ [symbol] ^{D}^{_{hand}}, both projecting into a common token dimension D_{M}.

The total number of token amounts to 3×T_{w}, where 3 accounts for the head and both hands, and T_{w} may be the sequence length. Sinusoidal positional encoding (PE) may be used for both the encoder 116 and the decoder 118 patches which suffices for learning different modalities, compared to learnable PE. In an HMD environment, the processor 112 may assume that the head tracking signal [symbol] _{head} is available, but hand visibility may depend on the ego-centric video. Thus, masking may be applied only to the hand tokens based on their visibilities within ego-centric view.

In contrast to other MAE training approaches, which maintain a consistent number of masked patches due to a fixed masking ratio, the count of frames with invisible hand may vary across different scenarios. To address this variability, the encoder 116 may selectively apply attention masking to these inputs, ensuring that queries do not attend to tokens where hand may be invisible. This attention masking technique adapts dynamically to the fluctuating numbers of missing frames across the instances, thereby providing the benefit of enhancing the model's ability to handle data sparsity effectively. For the decoder 118, an MAE decoder design may be utilized except the last projection layer may be implemented to guide the uncertainty. To capture the uncertainty, the processor 112 may split the final projection layer into two heads for mean and variance of a Gaussian distribution.

### Temporal Completion-Uncertainty-Aware Mae

To make the MAE aware of the predictive uncertainty of imputed hand pose sequence, the processor 112 may employ a β-NLL loss function to manage uncertainty by using a set of mean heads μᵢ(x) and variance heads σ²(x), which may be derived from M models initialized differently, where x=[ [symbol] ; [symbol] ] may be an input to the MAE and i∈[1, M]. The mean heads μᵢ(x) and variance heads σᵢ²(x) may be trained using the Gaussian negative log-likelihood loss, which applies to each sample indexed by n with input xₙ and ground truth hand pose sequence yₙ:

$${L}_{β - NLL} ( {y}_{n} , {x}_{n} ) = sg ( {σ}_{i}^{2 β} ) {L}_{NLL} ( {y}_{n} , {x}_{n} ) , where \qquad ( 2 )$$

$${L}_{NLL} ( {y}_{n} , {x}_{n} ) = \frac{log {σ}_{i}^{2} ( {x}_{n} )}{2} + \frac{{( {μ}_{i} ( {x}_{n} ) - {y}_{n} )}^{2}}{2 {σ}_{i}^{2} ( {x}_{n} )} \qquad ( 3 )$$

The L_{NLL} loss function may cause the predicted variance to act as a weighting factor for each data point, emphasizing those with higher variances. The parameter B may be utilized to adjust the intensity of this weighting. The sg(⋅) function may be used to apply the stop-gradient operation, thus mitigating gradients from propagating through this part of the computation.

After training, the processor 112 may measure the aleatoric (data) uncertainty [symbol] ₐₗₑ(⋅) by averaging the variances across models, and epistemic (model) uncertainty [symbol] ₑₚᵢ(⋅) by calculating variance of model means, and total uncertainty by adding both uncertainties:

$${𝒰}_{ale} ( x ) = {𝔼}_{i} [ {σ}_{i}^{2} ( x ) ] \approx {M}^{- 1} {\sum }_{i} {σ}_{i}^{2} ( x ) \qquad ( 4 )$$

$${𝒰}_{epi} ( x ) = {Var}_{i} [ {μ}_{i} ( x ) ] \qquad ( 5 )$$

$${𝒰}_{tot} ( x ) = {𝒰}_{ale} ( x ) + {𝒰}_{epi} ( x ) \qquad ( 6 )$$

[symbol]

ₐₗₑ(⋅) and [symbol] ₑₚᵢ(⋅) may provide uncertainties for each frame and each pose state dimension.
Spatial Completion: Uncertainty-Guided Body Pose Generation from Imputed Hand Trajectories and Head Tracking Signal

The processor 112 may employ a Vector Quantized Diffusion model (VQ-Diffusion) to generate full body ego-body poses from imputed hand trajectories and the head tracking signal. The processor 112 may generate human motion sequences from the temporally dense hand and head trajectories with uncertainty obtained from the MAE model. The VQ-Diffusion model and/or the MAE model may be received via the communication interface 152 and stored on the storage drive 142.

The processor 112 may train the VQ-VAE to represent human motion with a discrete codebook representation. After the codebook representation is learned by the VQ-VAE, the processor 112 may utilize this latent codebook representation to train a denoising diffusion model. Similarly, the denoising diffusion model may be received via the communication interface 152 and stored on the storage drive 142.

### Denoising Transformer

The denoising transformer 122 may estimate the distribution p(z₀|zₜ, y). To incorporate the diffusion step t into the network, the processor 112 may employ the adaptive layer normalization (AdaLN). Further, the processor 112 may concatenate the estimated hand and head trajectory with the codebook after an embedding layer, to match the dimension with codebook representation. Finally, the processor 112 may use the decoder 118 to decode z₀ to obtain a full body pose sequence.

### Uncertainty Guidance

Several strategies may be implemented to guide the denoising process using uncertainty estimates of imputed hand trajectories, such as sampling, dropout, and distribution embedding.

For sampling, the processor 112 may sample a hand sequence from the distribution [symbol] ˜ [symbol] (μ*(x), [symbol] ) and regard it as the conditioning vector y, where μ*(x)= [symbol] ᵢ[μᵢ(x)]≈M⁻¹Σᵢμᵢ(x) and [symbol] *(x) may be measured by one of Eq. (9), (10), and (11). While it may be ideal to sample multiple times to better approximate the marginalization in Equation (1), using merely one sample generally provides a competitive performance.

For dropout, the processor 112 may set each dimension of μ(x) to zero with a certain probability, which may be determined by the corresponding dimension of [symbol] *(x), and denote the result as y. The probability of the d-th dimension of μ(x) being zero may be

$${p}_{d} = 1 - ( {𝒰}_{d}^{*} ( x ) - {𝒰}_{{d}^{min}}^{*} ( x ) ) / ( {𝒰}_{{d}^{max}}^{*} ( x ) - {𝒰}_{{d}^{min}}^{*} ( x ) )$$

where

$${𝒰}_{d}^{*} ( x )$$

may be the d-th dimension of [symbol] *(x), and

$${𝒰}_{{d}^{min}}^{*} ( x ) , {𝒰}_{{d}^{max}}^{*} ( x )$$

may be the minimum and maximum values over the sequence length, respectively.

For distribution embedding, the processor 112 may embed the Gaussian distribution [symbol] (μ*(x), [symbol] ) to a vector by concatenating the μ*(x) and [symbol] *(x) in the feature dimension. The resulting embedding will be further concatenated with the head pose sequence to form a conditioning vector y.

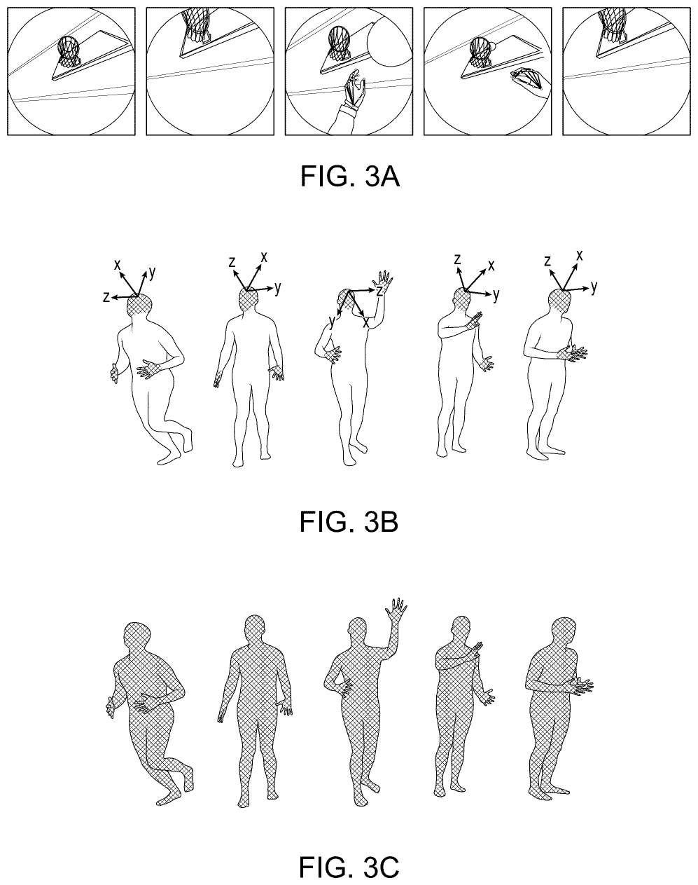

FIGS. 3A-3C are exemplary aspects related to ego-body pose estimation, according to one aspect. According to one aspect, a goal of the system for ego-body pose estimation may be to estimate ego-body pose without dependency on hand controllers in a head-mounted display (HMD) environment. In FIGS. 3A-3B, it may be seen that given the ego-centric input video and the input head tracking signal as input, the system for ego-body pose estimation may predict the hand pose in the frames where hands are visible. The system for ego-body pose estimation may then estimate the hand poses in frames with invisible hands using imputation, and estimate uncertainty associated with the hand poses where the hands are not visible. In FIG. 3C, the predicted hand pose, and the imputed hand pose may be used with head pose to predict the three-dimensional (3D) whole-body pose.

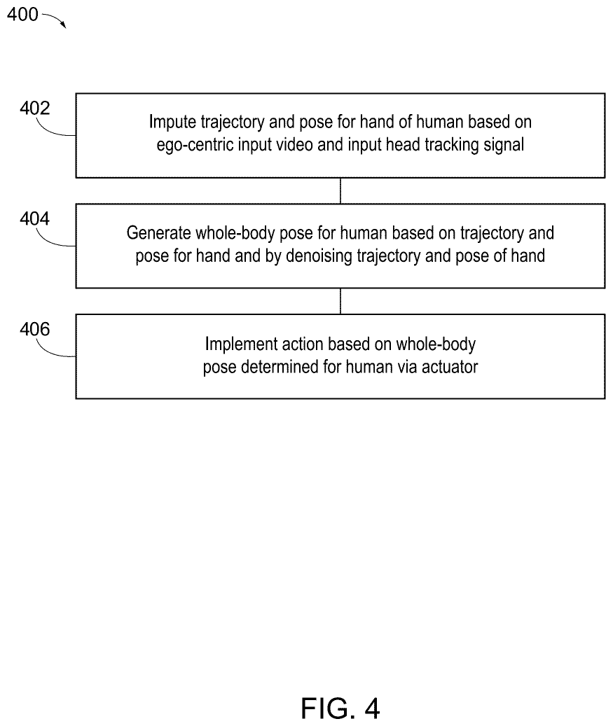

FIG. 4 is an exemplary flow diagram of a computer-implemented method 400 for ego-body pose estimation, according to one aspect. The computer-implemented method for ego-body pose estimation may include imputing 402 a trajectory and a pose for a hand of a human based on an ego-centric input video and an input head tracking signal, generating 404 a whole-body pose for the human based on the trajectory and the pose for the hand and by denoising the trajectory and the pose of the hand, and implementing 406 an action based on the whole-body pose determined for the human via an actuator.

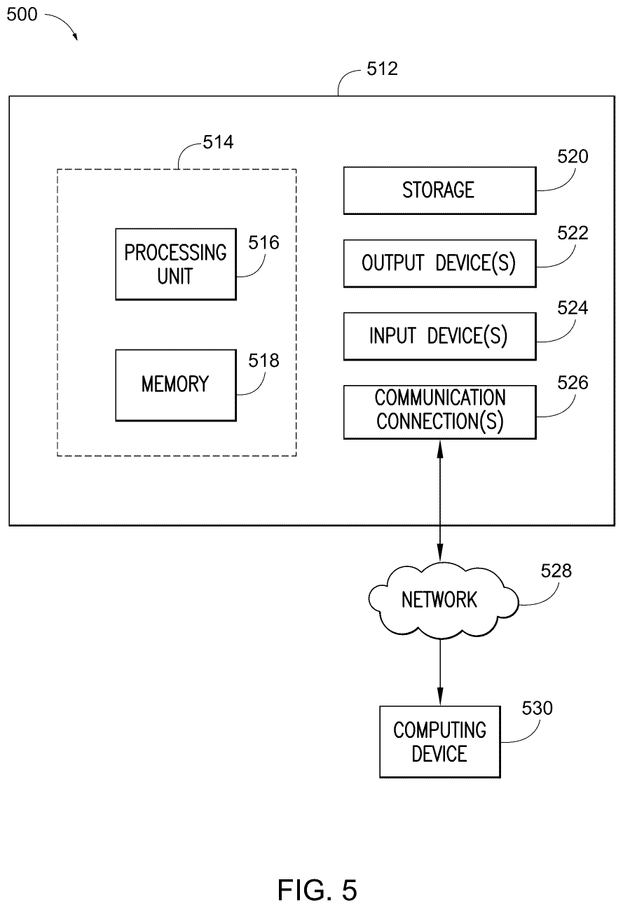

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions may be combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

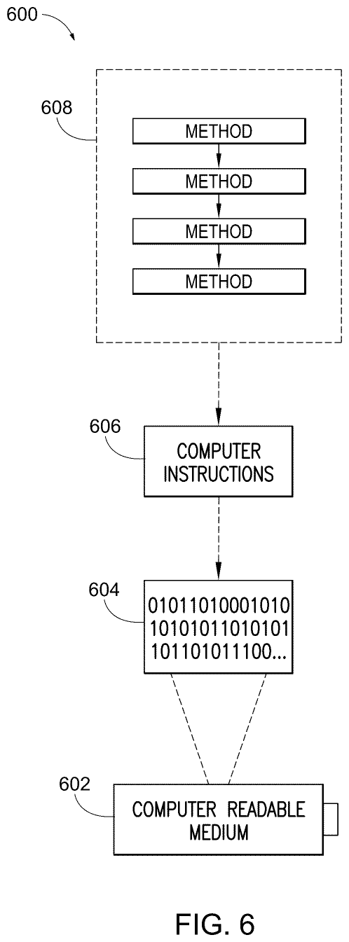

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 400 for ego-body pose estimation of FIG. 4. In another aspect, the processor-executable computer instructions 606 may be configured to implement a system, such as the system for ego-body pose estimation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for ego-body pose estimation, comprising:
a memory storing one or more instructions; and
a processor executing one or more of the instructions stored on the memory to perform:
imputing a trajectory and a pose for a hand of a human based on an ego-centric input video and an input head tracking signal; and
generating a whole-body pose for the human based on the trajectory and the pose for the hand and by denoising the trajectory and the pose of the hand.

2. The system for ego-body pose estimation of claim 1, comprising an actuator implementing an action based on the whole-body pose determined for the human.

3. The system for ego-body pose estimation of claim 1, wherein the processor imputes the trajectory and the pose for the hand of the human by passing input data including the input video and the input head tracking signal through a mask auto encoder (MAE).

4. The system for ego-body pose estimation of claim 3, wherein the input data is temporally sparse and spatially sparse.

5. The system for ego-body pose estimation of claim 3, wherein the input data includes joint information from only the hand of the human and a head of the human.

6. The system for ego-body pose estimation of claim 3, wherein the MAE does not require the same number of frames between the input video and a number of unknown frames.

7. The system for ego-body pose estimation of claim 1, wherein the input video includes one or more frames where the hand of the human is visible and one or more frames where the hand of the human is not visible.

8. The system for ego-body pose estimation of claim 1, wherein the whole-body pose for the human is generated by passing the imputed trajectory and pose for the hand of the human through a denoising transformer.

9. The system for ego-body pose estimation of claim 8, wherein the denoising transformer includes a diffusion model.

10. The system for ego-body pose estimation of claim 1, wherein the generating the whole-body pose for the human is based on a Vector Quantized-Variational Auto-Encoder (VQ-VAE).

11. A computer-implemented method for ego-body pose estimation, comprising:
imputing a trajectory and a pose for a hand of a human based on an ego-centric input video and an input head tracking signal; and
generating a whole-body pose for the human based on the trajectory and the pose for the hand and by denoising the trajectory and the pose of the hand.

12. The computer-implemented method for ego-body pose estimation of claim 11, comprising implementing an action based on the whole-body pose determined for the human via an actuator.

13. The computer-implemented method for ego-body pose estimation of claim 11, wherein the imputing the trajectory and the pose for the hand of the human is based on passing input data including the input video and the input head tracking signal through a mask auto encoder (MAE).

14. The computer-implemented method for ego-body pose estimation of claim 13, wherein the input data is temporally sparse and spatially sparse.

15. The computer-implemented method for ego-body pose estimation of claim 13, wherein the input data includes joint information from only the hand of the human and a head of the human.

16. A system for ego-body pose estimation, comprising:
a sensor receiving an ego-centric input video and an input head tracking signal;
a memory storing one or more instructions; and
a processor executing one or more of the instructions stored on the memory to perform:
imputing a trajectory and a pose for a hand of a human based on the ego-centric input video and the input head tracking signal; and
generating a whole-body pose for the human based on the trajectory and the pose for the hand and by denoising the trajectory and the pose of the hand.

17. The system for ego-body pose estimation of claim 16, comprising an actuator implementing an action based on the whole-body pose determined for the human.

18. The system for ego-body pose estimation of claim 16, wherein the processor imputes the trajectory and the pose for the hand of the human by passing input data including the input video and the input head tracking signal through a mask auto encoder (MAE).

19. The system for ego-body pose estimation of claim 18, wherein the input data is temporally sparse and spatially sparse.

20. The system for ego-body pose estimation of claim 18, wherein the input data includes joint information from only the hand of the human and a head of the human.
